(19) United States
(12) Patent Application Publication
(10) Pub. No.: US 2014/0064452 A1
(43) Pub. Date: Mar. 6, 2014

(54) METHOD FOR MEASUREMENT OF WEIGHT CONCENTRATION OF CLAY IN A SAMPLE OF A POROUS MATERIAL

(71) Applicant: SCHLUMBERGER TECHNOLOGY CORPORATION, Sugar Land, TX (US)

(72) Inventors: DMITRY MIKHAILOV, MOSCOW (RU); VALERY VASILIEVICH SHAKO, MOSCOW (RU); EVGENY CHUVILIN, MOSCOW (RU); VIKTORIA KRUPSKAYA, MOSCOW (RU)

(73) Assignee: SCHLUMBERGER TECHNOLOGY CORPORATION, Sugar Land, TX (US)

(21) Appl. No.: 14/015,939

(22) Filed: Aug. 30, 2013

(30) Foreign Application Priority Data
Sep. 3, 2012 (RU) 2012137225

(51) Int. Cl. G01N 23/207

(52) U.S. Cl. CPC G01N 23/207
USPC 378/71

(57) ABSTRACT

A solution of a clay material is pumped through a sample of a porous material. After completion of pumping, at least a part of the sample is crushed into powder and a clay fraction is elutriated from the prepared powder. X-ray diffraction analysis of the elutriated clay fraction is performed and weight concentration of clay material in the sample of the porous material is determined.

### CROSS-REFERENCE TO RELATED APPLICATION

This application claims priority to Russian Application No. 2012137225 filed Sep. 3, 2012, which is incorporated herein by reference in its entirety.

### FIELD

Embodiments herein relate to methods of non-destructive testing of samples of porous materials. In particular, it may be used for quantitative examination of deterioration of properties of oil/gas containing formations (“formation damage”) due to invasion, in the process of drilling, of clay materials contained in a drilling mud.

The problem of formation damage under the impact of drilling mud (or flushing liquid) is very important, especially for long horizontal wells, because most of them have open-hole completions, i.e., without cemented and perforated production casing.

Drilling muds are complex mixtures of clay, small particles (with dimensions from several millimeters to less than one micron) and organic additives (polymers, surfactants, etc.) contained in a ‘carrier’ liquid—the ‘base’ of the drilling mud, as such, water, oil or some synthetic liquid may act.

In the process of drilling, under the action of excess pressure drilling mud filtrate as well as small particles and clay contained in it invade into the near-borehole zone of a formation and cause a considerable decrease of its permeability (for characterizing this phenomenon, the term ‘damage of the near-borehole zone of formation’ or simply ‘formation damage’ is usually used.

During the technological procedure of clean-out of the well (by means of gradual putting on production), these components are partly flowed back from the near-borehole zone and its permeability is partly restored. Nonetheless, part of these components remains retained in the pore space (adsorption on pore surfaces, capture in pore channel bottlenecks, etc.), that resulting in a considerable difference between the initial permeability and the permeability restored after performance of the technological procedure of clean-out (a value of restored permeability usually does not exceed 50-70% if the initial one).

The generally accepted laboratory method for quality control of a drilling mud is the filtration experiment consisting in injection of drilling mud into a core sample with subsequent back-pumping of it (i.e., displacement of the invaded drilling mud with the initial formation fluid by injecting it from the opposite end of the core sample), in the course of this experiment the dynamics of deterioration/restoration of permeability is measured as function of number of injected pore volumes of fluids (drilling mud or formation fluid).

However, concentration of clay and other components of a drilling mud retained in the pore space after back-pumping are important information for understanding the mechanism of formation damage and selecting an appropriate method for enhancement of productivity index of a well (minimization of damage to the near-borehole zone of the formation). These parameters are not measured within the framework of the above-mentioned procedure of quality check of drilling mud.

Quantitative analysis of formation damage mechanisms associated with invasion of clayey materials in the process of drilling is of highest interest due to wide-spread usage of drilling muds on clay base.

Weight concentration of clay penetrated into the pore space in the course of impact of drilling mud is usually low (does not exceed 1-1.5% by weight). Nonetheless, due to a high swelling factor of clay and its porosity, such low weight concentration results in a considerable (with a factor of 5-20) reduction of rock permeability.

The technical problem is associated with the difficulty of measuring a low concentration of clay in a porous material, because X-ray diffraction analysis and X-ray computer tomography do not provide sufficient resolution for weight concentrations of a material <1%.

In U.S. Pat. No. 4,540,882, as well as No. 5,027,379, methods are Itemed for determining invasion depth of a drilling mud with the use of X-ray computer tomography of a core with addition of a contrast agent. But utilization of a contrast agent soluble in the ‘carrier fluid’ does not make it possible to evaluate the depth of penetration and concentration of clay and other low-contrast additives contained in the drilling mud, because depth of invasion of drilling mud filtrate and of the said additives in the general case are different.

In U.S. Pat. No. 5,253,719, a method is suggested for diagnosing formation damage by means of analyzing radially oriented core samples taken from a well. Core samples are analyzed with the use of a set of different analytical methods for determining the type and the degree of formation damage, as well as the depth of the damaged zone. Among the analytical methods listed are X-ray diffraction (XRD) analysis, scanning electronic microscopy (SEM), back-scatter electronic microscopy, petrographic analysis, optical microscopy.

In accordance with the standard technique, X-ray diffraction (XRD) analysis is performed on a crushed into powder piece of a core sample with a weight of 1 gram. The purpose of the method is identification of types of minerals and measurement of relative amounts of minerals presented in a core sample. A core may be divided into several segments that are numbered, for example, in the order of remoteness from the borehole wall into the formation depth. In this case, relative amount of minerals in each segment measured with the use of X-ray diffraction (XRD) analysis may be used for determining the type and degree of formation damage, as well as the depth of damage.

However, the methods listed in the above-mentioned patent are not applicable for measuring small contents of clay (less than 1% weight concentration). X-ray diffraction (XRD) analysis performed in accordance with the standard technique does not allow measurement of a small concentration of clay where this concentration does not exceed 1% by weight.

### DETAILED DESCRIPTION

The technical result achieved through implementation of this invention consists in the possibility to measure a small concentration of clay material that penetrated into a pore space in the course of pumping a clay-containing fluid.

In accordance with the suggested method for determining weight concentration of a clay material in a sample of a porous material, a solution of clay material is pumped through a sample of a porous material, after completion of pumping, at least a part of the sample is crushed into powder, a clay fraction is elutriated from the prepared powder, X-ray diffraction analysis of the elutriated clay fraction is performed and weight concentration of the clay material is determined.

It is preferable that the part of the sample of the porous material for crushing is detached from the sample near an end into which the solution of clay material was pumped.

The part of the sample of the porous material detached for crushing should have a weight not less than 1 gram.

As an example of implementation of the method, measurement of concentration of bentonite clay that penetrated into a porous sample after pumping of a 2% solution of this clay through it was performed.

After preparing a 2% solution of bentonite clay with addition of sodium chloride (18 g/l), a filtration experiment in pumping of the prepared 2% clay solution into a sample of a porous material. Nine pore volumes (the ratio of volume of the pumped solution to the volume of the pore space of the sample) were pumped-through, and thereafter, due to a considerable decrease of permeability, filtration practically discontinued and the experiment was stopped.

From the sample of the porous material near the input end (i.e., the end into which injection of the clay solution was made), a part with 20 grams weight was detached by means of cracking (a detached and crushed part preferably should be not less than 1 gram), this part of the sample was crushed and was placed into water for decanting (separation of solid particles using difference of their fall velocities in a liquid) of the fine fraction. By decanting in water, 1 gram of the fine fraction with grain size less than 4 μm was separated.

In accordance with the generally accepted technique (see, for example Puscharovsky D. Y. X-ray imaging of minerals. 2000, M.: <<Geoinformmark>>, 2000, p. 292 c. or Shlykov V. G. X-ray analysis of mineral composition of dispersive rocks. M. Geos. 2006, pp. 76-102, X-ray diffraction (XRD) analysis of the fine fraction was performed for determining its mineral composition. Weight concentration is determined by the standard technique (Shlykov V. G. X-ray analysis of mineral composition of disperse rocks, Moscow: Geos. 2006, pp. 76-102; Shlykov V. G. X-ray examinations of soils. Training manual.—Moscow: Publishing house of the Moscow State University, 1991, 184 p.).

Weight concentration of bentonite clay measured with the use of X-ray diffraction analysis of the decanted fine fraction was recalculated with respect to mass of the initial crushed part of the sample.

The final value of weight concentration of bentonite clay in the sample of the porous material after pumping-through of a 2% solution of bentonite clay equals 1.6%.

1. A method for determining a weight concentration of a clay material in a sample of a porous material comprising:
pumping a solution of a clay material through the sample of the porous material,
crushing at least a part of the sample into powder,
elutriating the clay fraction from the produced powder,
performing X-ray diffraction analysis of the elutriated clay fraction and determining the weight concentration of clay material.

2. The method of claim 1, wherein the part of the sample of the porous material for crushing is detached from the sample near an end into which the clay material was pumped.

3. The method of claim 1, wherein the part of the sample of the porous material detached for crushing has a weight not less than 1 gram.
